(19) United States
(12) Patent Application Publication
(10) Pub. No.: US 2004/0247085 A1
(43) Pub. Date: Dec. 9, 2004

(54) Apparatus for use in imaging an animal extremity

(76) Inventor: Don M. Byrne, Conroe, TX (US)

Correspondence Address: Browning Bushman P.C., Suite 1800, 5718 Westheimer, Houston, TX, 77057-5771, US

(21) Appl. No.: 10/455,064

(22) Filed: Jun. 5, 2003

(51) Int. Cl. H05G 1/00

(52) U.S. Cl. 378/208

(57) ABSTRACT

An apparatus for use in the imaging of at least a portion of an animal extremity comprising a support having first and second generally parallel side frame portions, each of which define latch engageable formation, a plate carried by the support, the plate having a surface for contact with the portion of the animal extremity to be examined, a first clip resiliently removably attached to one of the frame portions, the clip having a latching formation engageable with the latch receiving formation on the frame portion, the clip including a strap receiving formation, a second clip secured to the other frame portion, the second clip including a strap receiving formation, and a strap having a first portion attached to the first clip and a second portion attached to the second clip, at least one of the strap receiving formations being operable to permit adjustment of the strap along its length and to hold the strap in a selected position above the surface.

### BACKGROUND OF THE INVENTION

1. Field of the Invention

The present invention relates to an imaging apparatus. More particularly, the present invention relates to an apparatus for imaging an animal extremity, e.g. a human leg by x-rays or the like. More specifically, the present invention relates to such an apparatus that property secures an animal extremity in its desired position adjacent to an imaging plate.

2. Description of the Prior Art

Imaging plates are commonly used for the examination of a human extremity. Such imaging plates can include x-ray plates which use radiation for providing an image of the interior of the human extremity. Following the application of radiation onto a human extremity placed adjacent to the imaging plate, a humanly perceivable image of the interior of the human extremity can be properly presented. During such imaging activities, it is vitally important that the human extremity be placed in a fixed position against the imaging plate. If there is any movement between the human extremity and the imaging plate, then the image produced therefrom will be an inaccurate representation of the interior of the human extremity. As such, a need has developed so as to properly maintain the human extremity in its desired position against the imaging plate during the period of time of which the radiation is applied.

FIG. 1 shows an existing prior art imaging plate apparatus. In FIG. 1, it can be seen that the imaging plate structure 10 includes an imaging plate 12 with a frame 14 extending around a perimeter thereof. A transparent plastic bag 16 will completely surround the imaging plate 12 and the frame 14 so as to maintain the imaging plate 12 and the frame 14 in a sterile condition.

Various techniques have been used in the past so as to properly affix a human extremity in a desired position over the imaging plate 12. These devices include various type of clamps, tapes, and other devices which secure the human extremity in its desired position. These prior art devices have been difficult to use and often interfere with the sterility of the imaging plate.

FIG. 2 shows another type of prior art device which serves to affix a human extremity in its desired position relative to the imaging plate. In FIG. 2, it can be seen that a housing 18 is provided with straps 20, 22 and 24 extending over a top surface 26 thereof. Each of the straps 20, 22 and 24 can be secured in their desired position by affixation members associated therewith. Affixation members 28 and 30 are used in association with strap 20. These devices can be of various configurations but serve to allow the user to properly tighten the strap 20 against the human extremity so as to fix the human extremity in its desired position. Affixation members 32 and 34 are associated with strap 22. Affixation members 36 and 38 are associated with strap 24. In FIG. 2, the straps 20, 22 and 24 simply serve to secure the human extremity onto the outside surface 26 of the housing 18. The actual imaging plate structure 40 is removed from a transparent bag (such as transparent bag 16, shown in FIG. 1) and slidably received within the interior of the housing 18 in a desired position. Following the imaging, the imaging plate structure 40 can be slidably removed from the interior of housing 18 for the production of the actual image. Following use, the housing 18 can be delivered elsewhere for re-sterilization or can be disposed of.

The prior art device of FIG. 2 is rather complex to manufacture. For example, the housing 18 would conventionally be formed of an injection molded polymeric material. The injection molded polymeric material which is used to form the housing 18 should be configured so as to accurately receive the imaging plate structure 40 therein. Furthermore, the affixation members 28, 30, 32, 34, 36 and 38 must be properly affixed to the polymeric housing 18. The straps 20,22 and 24 must then be installed within the respective affixation members. During use, the imaging plate structure 40 must be removed from the transparent bag. As such, there would be a risk of contamination of the imaging plate structure 40 during its removal from the transparent bag. The imaging plate structure 40 must then slide into an accurate and desired position within the interior of the housing 18. If there is any imprecision in the manufacture of the housing 18, then the imaging plate structure 40 can be improperly positioned in the interior of the, housing 18.

### SUMMARY OF THE INVENTION

It is an object of the present invention to provide an apparatus which can be used to secure an animal extremity in a desired position over an imaging plate.

It is another object of the present invention to provide an apparatus which can be removably affixed over the sterile transparent bag on the imaging plate.

It is another object of the present invention to provide a clip for an imaging plate structure which allows a strap to be adjustably affixed in position over the imaging plate.

It is another object of the present invention to provide an imaging plate apparatus which is inexpensive, easy to manufacture and easy to use.

These and other objects and advantages of the present invention will become apparent from a reading of the attached specification.

In a preferred embodiment, the apparatus of the present invention includes a support that has first and second spaced, generally parallel frame portions, the first and second frame portions defining first and second latch engageable formations. A plate is carried by the support, the plate having a surface for contact with at least a portion of an animal extremity. There is a first clip resiliently, removably secured to the first frame portion, the clip having a latching formation engageable with the latch receiving formation. The first clip includes a strap receiving formation and there is a second clip secured to the second frame portion, the second clip also including a second strap receiving formation. A first strap has a first portion attached to the first clip and a second portion attached to the second clip, at least one of the strap receiving formations being operable to permit adjustment of the strap along its length and to hold the strap in a selected position above the surface of the plate.

In a preferred form, the clip of the present invention comprises a first arm, a second arm and a joint member positioned between the first and second arms. The first arm has a back surface suitable for pressing so as to lift a forward end of the first arm from compressive contact with a surface, such as the second arm or the imaging plate. The back surface of the first arm includes a slot formed therein. The slot tapers so as to have a narrow end away from the end of the first arm. The slot opens to the end of the first arm. The slot is suitable for the receipt of a strap therein. The strap is inserted so as to be in interference fit relationship in the narrow end of the slot. The first arm includes a first surface with a widened portion for contact with the imaging plate and a narrow portion for contacting the frame of the imaging plate. The front surface includes a pair of members in parallel coplanar relationship having a space therebetween.

The second arm of the clip has a back surface and a front surface. The second arm has a widened portion for contacting the imaging plate and a narrow portion for contacting the frame. A shoulder is formed between the narrow portion and the widened portion. The second arm includes a pair of members in a coplanar parallel relationship and aligned with the members of the first arm. These pairs of members have a roughened interior surface so as to allow for frictional engagement with the imaging plate.

The joint member is positioned between the first and second arms. The joint member is arranged generally transverse to the first and second arms. The first and second arms are pivotally and elastically connected to the joint member. The joint member is connected to the first and second arms in an area between the respective back surfaces and front surfaces of the first and second arms. The first arm, the second arm and the joint member are preferably, integrally formed of a polymeric material. Preferably, the clip is formed of the polymeric material having a memory so that the arms return to compressive contact with each other upon removal from the imaging plate structure.

### BRIEF DESCRIPTION OF THE DRAWINGS

FIG. 1 is a perspective view showing a prior art imaging plate structure.

FIG. 2 is a diagrammatic illustration of a prior art mechanism for securing a human extremity against a housing used to receive the imaging plate structure.

FIG. 3 is an upper perspective view of the clip in accordance with the present invention.

FIG. 4 is a plan view of the clip in accordance with the present invention.

FIG. 5 is a diagrammatic illustration showing the clip as connected to the frame and imaging plate of an imaging plate structure.

FIG. 6 is a plan view showing the securing of the respective clips and strap over the imaging plate structure.

FIG. 7 is a cross-sectional view showing the securing of the clip to the imaging plate structure.

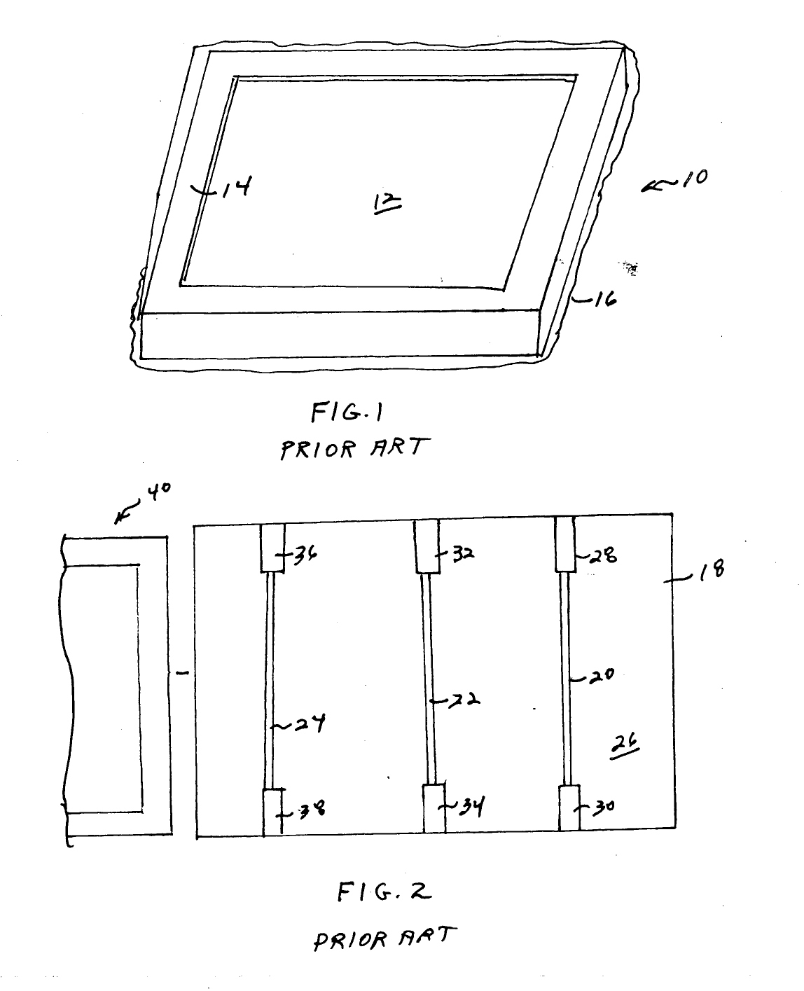

### DETAILED DESCRIPTION OF THE INVENTION

Referring to FIG. 3, there is shown the clip 50 in accordance with the teachings of the present invention. The clip 50 includes a first arm 52, a second arm 54, and a joint member 56 extending therebetween. The first arm 52, the second arm 54 and the joint member 56 are integrally formed together of a polymeric material. In the preferred embodiment of the present invention, the polymeric material used for the formation of the clip 50 is of a polycarbonate material so that the clip 50 exhibits a suitable memory so that the respective arms 52 and 54 will return to a compressive contact position when released.

The first arm 52 has a back surface 58 and a front surface 60. The back surface 58 extends outwardly beyond the joint member 56 so as to provide a surface for pressing the first arm 52 so as to lift the front surface 60 from compressive contact with another surface. A slot 62 is formed in the back surface 58 of the first arm 52. The slot 62 includes a generally semicircular indentation 64 leading to a tapered area 66. The tapered area 66 narrows so as to have a narrow end 68 away from the semicircular indentation 64. The tapered area 66 opens at the semicircular indentation 64. The slot 62 is suitable for the receipt of a strap therein. The strap can be inserted and pushed towards the narrow end 68 so as to be in interference fit relationship with the narrow end 68 of the slot 62.

The front surface 60 has a widened portion 70 and a narrow portion 72. A shoulder 74 is formed therebetween. The widened portion 70 serves for contact with the imaging plate. The narrow portion 72 is suitable for contacting the frame of the imaging plate. The shoulder 74 will extend in the area between the imaging plate and the frame when the clip 50 is applied to such a imaging plate structure. The front surface 60 includes a pair of members 76 and 78 which extend outwardly as separate arms. A space 80 is formed between the members 76 and 78.

The second arm 54 has a back surface 80 and a front surface 82. The back surface 80 lacks the slot associated with the back surface 58 of the first arm 52. The back surface 80 is positioned relative to the back surface 58 of the first arm 52 so as to allow the fingers of a user to press the back surfaces 58 and 80 towards each other, relative to the joint member 56, so as to lift the front surfaces 60 and 82 away from each other. The front surface 82 includes a widened portion 84 and a narrow portion 86. The widened portion 84 serves to contact the imaging plate. The narrow portion 86 serves to contact the frame. A suitable shoulder 88 is formed therebetween so as to reside in proximity to the area between the imaging plate and the frame. The front surface 82 includes a pair of members 90 and 92 in coplanar parallel relationship. These members 90 and 92 are aligned respectively with members 76 and 78 of the first arm 52. It can be seen that each of the members 90 and 92 has a roughened surface 94 so as to provide strong frictional contact with the imaging plate or the transparent bag extending thereover.

Joint member 56 is positioned between the first arm 52 and the second arm 54 in an area between the respective back surfaces 58 and 80 and the front surfaces 60 and 82. The joint member 56 is arranged transverse to the first arm 52 and the second arm 54. The joint member 56 has one end pivotally connected to the first arm 52 and another end pivotally connected to the second arm 54. The joint member 56 should, desirably, have a length at least equal to the thickness of the imaging plate to which the clip 50 is applied.

FIG. 4 is a plan view showing the first arm 52 of the clip 50 of the present invention. The clip 50 includes aback surface 58 having slot 62 formed therein. The slot 62 has a narrow end 68 into which the strap can be forcibly pushed. Generally, semicircular indentation 64 extends from the back end 98 of the first arm 52 towards the widened end 100 of the tapered area 66. The semicircular indentation 64 will “funnel” the strap into the slot 62. The semicircular indentation 64 will open widely at the back end 98 of the first arm 52.

The first arm 52 has a front surface 60 having members 76 and 78 extending outwardly therefrom. A space 80 is formed between the members 76 and 78. The space 80 avoids any interference or obstruction with the actual imaging technique.

FIG. 5 shows the manner in which the clip 50 can be secured to an imaging plate structure 102. FIG. 5 also shows how a strap 104 can be secured to the first arm 52 so as to allow for the extension over the imaging plate structure 102.

In FIG. 5, the imaging plate structure 102 includes an imaging plate 106 and frame 108 positioned between the first arm 52 and the second arm 54 of the clip 50. Imaging plate structure 102 has the frame 108 of greater thickness than the imaging plate 106. In this manner, the front surface 60 of the first arm 52 has its widened portion 70 extending over one surface of the imaging plate 106 and its narrow portion 72 extending over the frame 108. Shoulder 74 will be engaged against the shoulder formed between the frame 108 and the imaging plate 106. A similar arrangement is found for the second arm 54. The joint member 56 extends between the first arm 52 and the second arm 54 and resides generally juxtaposed against the outer surface of the frame 108. It can be seen in FIG. 5 that joint member 56 should have a length which is generally equal to or greater than the thickness of the frame 108.

In FIG. 5, it can be seen that the strap 104 has an end 110 which extends through the slot 62 and into the area between the back surfaces 58 and 80 of arms 52 and 54, respectively. By pulling on the end 110, the strap 104 can be lengthened or shortened so as to properly receive a human extremity thereunder.

FIG. 6 shows the application of the clips in accordance with the present invention in conjunction with an imaging plate structure. In FIG. 6, imaging plate structure 200 includes a frame 202 and an imaging plate 204. The frame 202 will extend around the perimeter of the imaging plate 204. A transparent plastic bag 206 will surround the frame 202 and the imaging plate 204. The transparent bag 206 will maintain the imaging plate 204 in a sterile contained environment.

Unlike the prior art, it is not necessary to remove the imaging plate 204 or the frame 202 from the bag 206. In order to carry out proper imaging activities, it is only necessary to affix clips 208, 210, 212 and 214 over the frame 202 of the imaging plate structure 200. In FIG. 6, it can be seen that a strap 216 will extend over the imaging plate 204 between the clips 208 and 210. The ends of the strap 216 are forcibly inserted into the slots associated with the clips 208 and 210 to an extent desired by a user.

Similarly, a strap 218 is secured to the clips 212 and 214 in the manner described herein previously. The clips 208, 210, 212 and 214 are fitted over the plastic bag 206 and the frame 202 so as to be compressively secured to the imaging plate structure 200. During use, a human extremity can be placed against the imaging plate 204 by simply placing the extremity under the straps 216 and 218 and then tightening the straps so as to prevent movement of the human extremity during the imaging process. Following the imaging process, the straps 216 and 218 can be appropriately loosened by pulling the strap from the slot and releasing the human extremity from its desired contact with the imaging plate 204. In all circumstances, the imaging plate 204 is maintained in a sterile condition by being received within the bag 206.

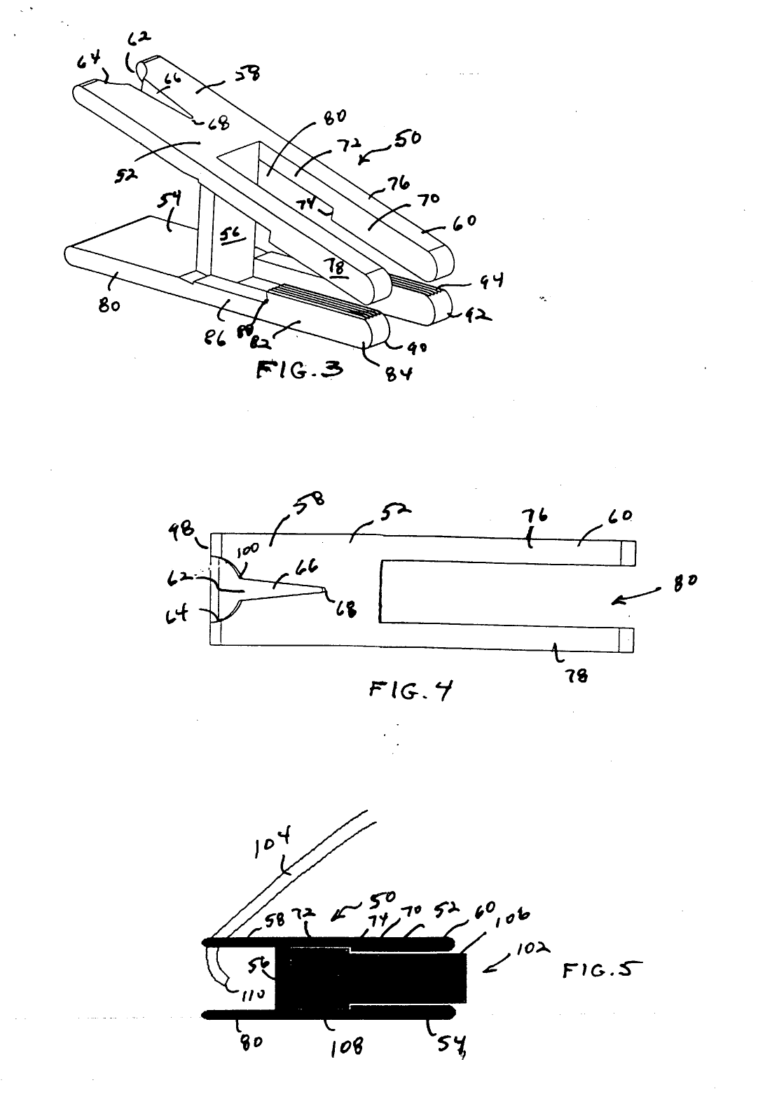

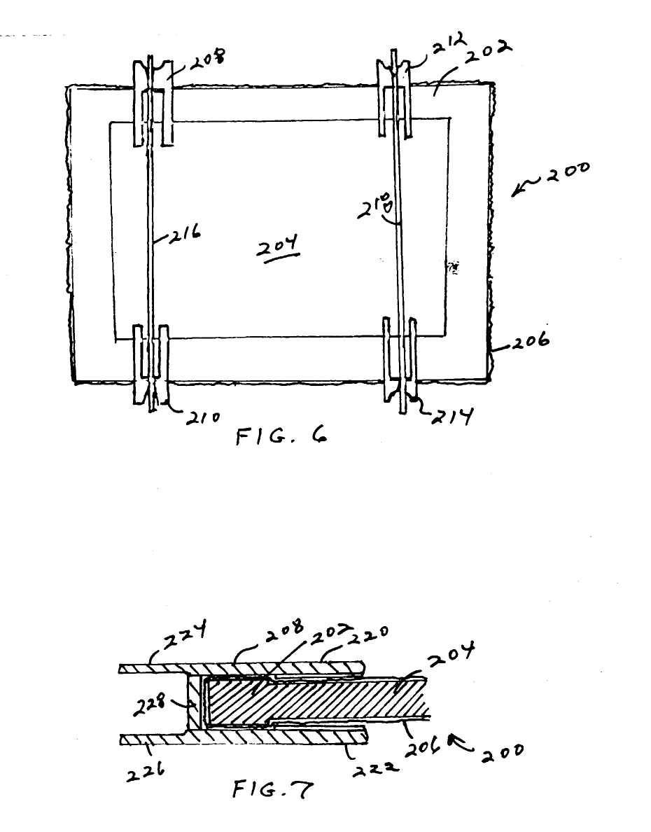

In FIG. 7, the arrangement of clip 208 is particularly illustrated. In FIG. 7, it can be seen that the clip 208 has a first arm 220 and second arm 222 extending over the frame 202 and the imaging plate 204, the imaging plate structure 200. The transparent plastic bag 206 surrounds the frame 202 and the imaging plate 204. As such, it can be seen that the clip 208 assumes a secure position relative to the imaging plate structure 200. The back surfaces 224 and 226 extend outwardly from the joint member 228 beyond the outer periphery of the frame 202. Back surfaces 224 and 226 provide an area whereby the user can simply press the back surfaces 224 and 226 so as to release the imaging plate structure 200 from the arms 220 and 222. The back surfaces 224 and 226 can be released so as to properly secure the clip 208 in its desired position. The respective clips 208, 210, 212 and 214 can be suitably moved, repositioned or adjusted as desired so as to place in security in an extremity in such desired position.

Although in the description above, the clip has been described as being integrally formed from a polymeric material, it will be apparent to those skilled in the art that such a construction is not necessary. For example, the first and second arms could be made of a metallic material and a separate joint member, e.g., a spring mechanism, could be positioned between and attached to the first and second arms in such a manner that the arms were normally resiliently biased into the position shown in FIG. 3, but could be opened such that the clip could engage the frame portion of the support. Furthermore, while in the description above and in the drawings, both clips are resiliently, removably attached to the frame of the support, the apparatus could be designed so that one of the clips was not resiliently removably secured to the frame but rather, just included a formation for receiving and holding one end of the strap. Indeed, the second “clip” could simply take the form of an integrally formed portion of the frame that simply held one end of the strap in place, the strap being tightened by pulling it through the strap receiving formation on the resiliently removable clip, such that the strap could be tightened across the animal extremity to the desired degree. As a practical matter, it is desirable that the strap be secured between first and second clips that are resiliently, removably secured to the opposed side frame portions so that they can be easily removed if desired.

One of the features of the apparatus of the present invention is that the clip has a configuration such that the strap can be pulled taught against the surface of the imaging plate, which insures that when the extremity of the animal, such as a human arm, is placed on the plate, the strap will securely hold the arm against the imaging plate. This low profile design is seen in FIG. 5 and it is apparent that when the strap 104 is attached to a clip on the opposite side of the frame, the strap would closely overlie the surface of the plate carried by the support.

Although, as described above and shown on the drawings, both of the clips permit adjustment of the strap, it will be apparent that only one of the clips need provide for such adjustment. In other words, when two removable clips are employed, one of the clip could be designed such it is simply held at one end of the strap, while the other clips was designed to permit adjustment of the strap, i.e., one of the clips could act as a fixed anchor point while the other clip could act as an adjustable anchor point in the sense that when the strap was pulled to the desired tautness, it would remain in that position until released.

The foregoing disclosure and description of the invention is illustrative and explanatory thereof. Various changes in the details of the illustrated construction can be made within the scope of the present invention without departing from the true spirit of the invention.

1. An apparatus for use in the imaging of at least a portion of an animal extremity comprising:
a support, said support including first and second spaced, generally parallel frame portions, said first and second frame portions defining first and second latch engageable formations;
a plate carried by said support, said plate having a surface for contact with said portion of said animal extremities;
a first clip resiliently, removably secured to said first frame portion, said clip having a latching formation engageable with said latch receiving formation, said first clip including a strap receiving formation, and a second clip secured to said second frame portion, said second clip including a second strap receiving formation;
a first strap having a first portion attached to said first clip and a second portion attached to said second clip, at least one of said strap receiving formations being operable to permit adjustment of said strap along its length and to hold said strap in a selected position above said surface.
